(19) United States
(12) Patent Application Publication
(10) Pub. No.: US 2020/0047784 A1
(43) Pub. Date: Feb. 13, 2020

(54) METHOD FOR TRANSMITTING MESSAGES

(71) Applicant: SIEMENS MOBILITY GMBH, MUENCHEN (DE)

(72) Inventor: WALDEMAR HARSCH, HANNOVER (DE)

(21) Appl. No.: 16/478,566

(22) PCT Filed: Dec. 19, 2017
(86) PCT No.: PCT/EP2017/083476

§ 371 Date: Jul. 17, 2019

(30) Foreign Application Priority Data
Jan. 17, 2017 (DE) 10 2017 200 630.7

(51) Int. Cl. B61L 7/08; H04L 29/08; H04L 1/08; B61L 27/00; B61L 15/00; B61L 19/06

(52) U.S. Cl. CPC B61L 7/08; H04L 67/12; B61L 19/06; B61L 27/0005; B61L 15/0027; H04L 1/08

(57) ABSTRACT

A method transmits messages. Accordingly, current information and the information previously transmitted as current information in the previous message is transmitted in each new message. The messages can be transmitted wirelessly or by a cable or wire. The message can be exchanged between rail vehicles and an interlocking, between two or more rail vehicles, or two or more interlockings.

The invention relates to a method for transmission of messages.

The underlying object of the invention is to specify a method that makes it possible, in the event of short-term disruptions to transmission, to be able safely to continue to operate a technical system that works on the basis of message transmission, for example a railway system.

In accordance with the invention this object is achieved by a method as claimed in claim 1. Advantageous embodiments of the inventive method are specified in the dependent claims.

Accordingly there is provision in accordance with the invention for the current information to be transmitted and for the information sent in the immediately preceding message to be transmitted once again in each case in each message.

A significant advantage of the inventive method lies in the fact that this makes it possible to continue to operate a technical system which for its safe operation requires a complete receipt of all messages, even if individual messages are not able to be received on the receiver side in the event of short-term disruptions to individual messages. In accordance with the invention information is namely not just sent once but twice or—depending on the embodiment variant of the method—a number of times so that, on the receiver side, information which has initially not been transmitted correctly or has not been able to be received or at least not received completely, can be obtained for subsequently received messages.

The method described is preferably employed in the field of railway technology in order to make it possible to continue the operation of the railway system in the event of just short-term transmission faults and to avoid an interruption in operation and the delays resulting therefrom; it is accordingly thus seen as advantageous if, within the framework of the method described, messages are transferred between components of a railway system.

The messages are preferably transferred in the form of data telegrams, in accordance with one of the following transmission standards for example: RFC 768—User Datagram Protocol, RFC 791—INTERNET PROTOCOL, RFC 793—TRANSMISSION CONTROL PROTOCOL or RFC 2460—Internet Protocol, Version 6 (IPv6).

Preferably in each message, in addition to the current information, both the information sent as current information in the immediately preceding message and also in addition the information sent as current information in one or more other previous messages (messages before last etc.) is sent. In this embodiment the transmission outage can be managed technically even in the event of two or more messages being lost in succession. In other words the following is thus preferably transmitted in each case in each message:
the current information,
the information sent as the current information in the immediately preceding message once again and
additionally at least one further item of information that had been sent as current information in another of the previous messages

The railway system preferably has trackside components as well as an interlocking controlling the trackside components.

In the last-mentioned embodiment of the railway system it is seen as advantageous for the trackside components, in each message to the interlocking, to send to the interlocking a current item of information about the operational status of the component or a current item of operational readiness information in each case as well as in addition the status information or operational readiness information sent in the last message.

In the aforementioned embodiment of the railway system it is also seen as advantageous—as an alternative or in addition—for the interlocking, in each message to a trackside component, to send to the respective trackside component a current item of command information or a current item of operational readiness information in each case as well as in addition the command information or current operational readiness information sent in the last message.

The method can also be employed in an advantageous manner in a railway system that has at least two interlockings; in such a railway system the messages are preferably transferred between the interlockings or at least between the interlockings as well.

Each interlocking, in each message to another interlocking, preferably sends to the respective other interlocking a current item of interlocking information or a current item of operational readiness information in each case and also additionally the interlocking information or operational readiness information sent in the last message in each case.

The method can also be employed in an advantageous manner in a railway system in which a rail vehicle is traveling on a section of track; the messages in this case are preferably sent between the rail vehicle and an interlocking or at least between the rail vehicle and the interlocking as well.

Preferably the rail vehicle, in each message to the interlocking, will send to the interlocking a current item of vehicle information as well as a current item of operational readiness information in each case as well as in addition the vehicle information or operational readiness information sent to the interlocking in the last message. The vehicle information preferably comprises details relating to the location of the rail vehicle established on the vehicle side and/or to the speed of the rail vehicle established on the vehicle side.

It is also advantageous for the interlocking, in each message to the rail vehicle, to send to the rail vehicle a current item of command information or a current item of operational readiness information in each case as well as in addition the current command information or current operational readiness information sent in the last message. Moreover the method can be employed in an advantageous manner in a railway system in which at least two rail vehicles are traveling on a section of track. In this case the messages are preferably transferred between the rail vehicles or at least between the rail vehicles as well.

It is especially advantageous for each rail vehicle, in each message to another rail vehicle, to send to the other rail vehicle in each case a current item of vehicle information or a current item of operational readiness information as well as in addition the vehicle information or operational readiness information sent in the last message.

The invention also relates to a railway component for a railway system. In accordance with the invention there is provision for the railway component to be embodied such that it can send messages wherein, in each message sent, a current item of information and once again the information sent as current information in the immediately preceding message is transmitted in each case.

With regard to the advantages of the inventive railway component, the reader is referred to the what has been stated above in connection with the inventive method.

The railway component is preferably an interlocking, a trackside component or a rail vehicle.

The invention also relates to a railway system that is equipped with a railway component, as has been described above. With regard to the advantages of the inventive railway system, the reader is referred to what has been stated above in connection with the inventive method.

The invention will be explained below in more detail with reference to exemplary embodiments; in the figures, by way of example:

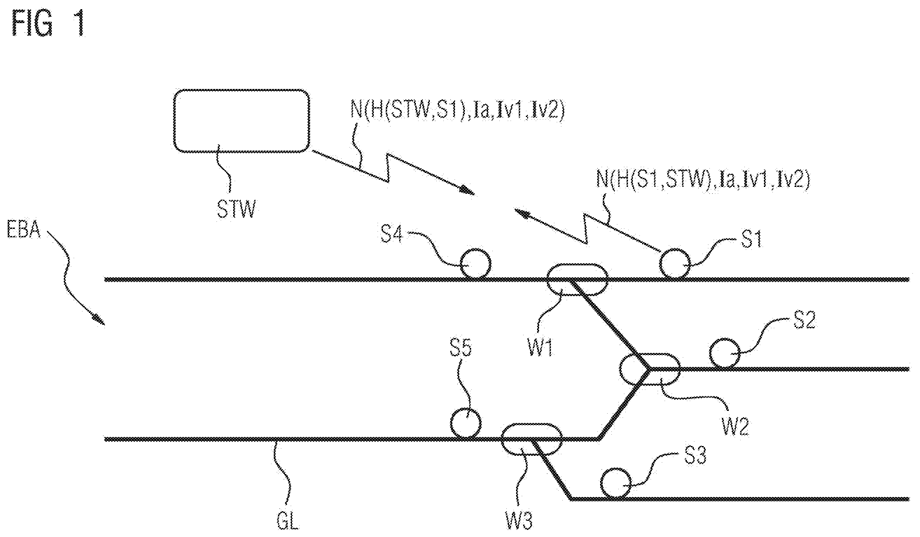

FIG. 1 shows a first exemplary embodiment of the inventive method on the basis of an exemplary embodiment of a railway system shown in a schematic view from above,

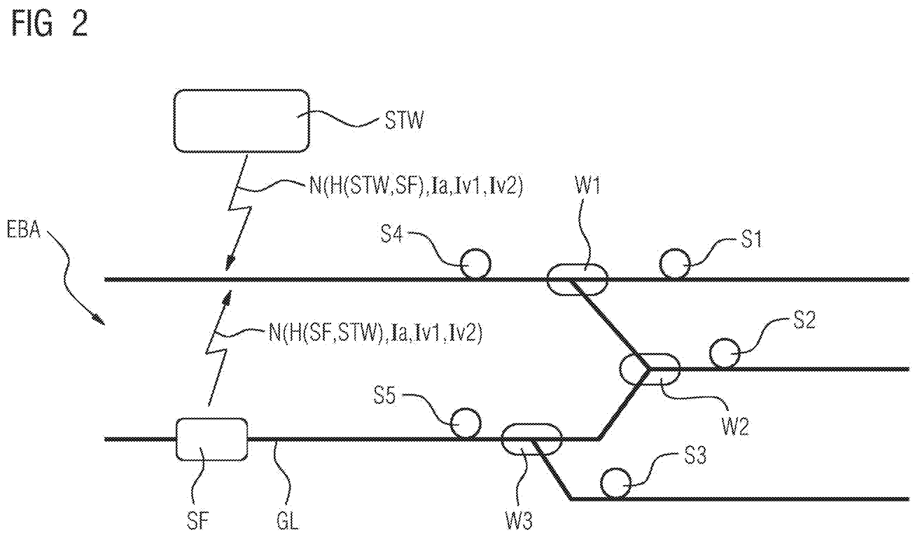

FIG. 2 shows a second exemplary embodiment of the inventive method on the basis of the railway system in accordance with FIG. 1,

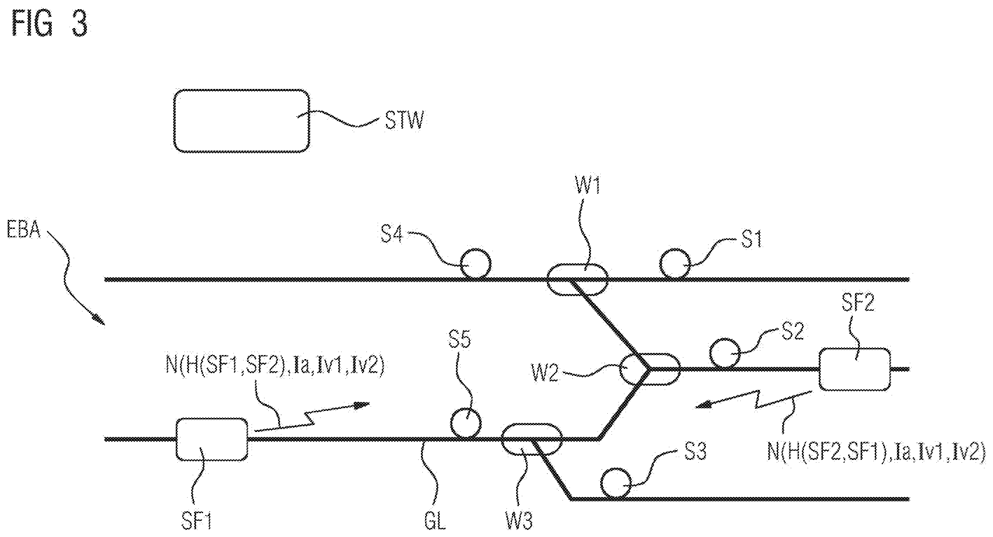

FIG. 3 shows a third exemplary embodiment of the inventive method on the basis of the railway system in accordance with FIG. 1,

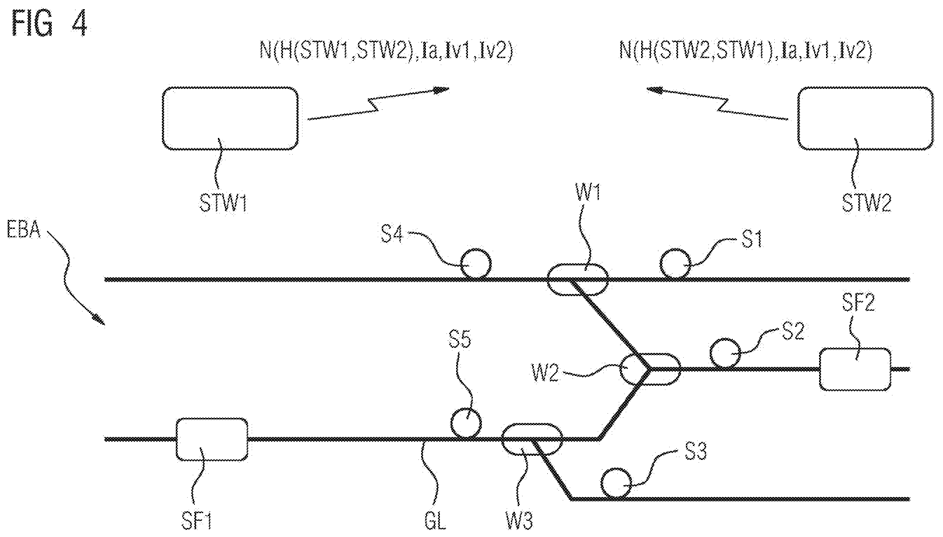

FIG. 4 shows a fourth exemplary embodiment of the inventive method on the basis of a further exemplary embodiment of a railway system shown in a schematic view from above.

In the figures, for the sake of clarity, the same reference numbers are always used for the identical or comparable components.

FIG. 1 shows, in a schematic view from above, an exemplary embodiment of a railway system EBA.

The railway system EBA, in addition to tracks GL, comprises trackside components, of which FIG. 1 shows signals S1, S2, S3, S4 and S5 as well as switches W1, W2 and W3 by way of example. The trackside components are monitored and controlled by an interlocking STW.

To make possible the monitoring and control of the trackside components by the interlocking STW, each of the trackside components exchanges messages with the interlocking STW. The messages can be transmitted in any given way as regards the transmission technology, for example by wire or via cables or, as an alternative or in addition, by means of radio.

For the transmission of the messages, in order to enhance redundancy, a current item of information Ia as well as in addition at least the information sent in the last message, is sent once again in each message in each case. In the exemplary embodiment depicted in FIG. 1, it is assumed for example that, in addition to the current information Ia, two items of previous information are sent as well, namely the previous information Iv1 that was sent as current information in the previous message and the information before last Iv2, which was sent as the current information in the message before last. As an alternative just one item of previous information can be transmitted or more than two items of previous information can be transmitted.

This will be explained below in more detail by way of example on the basis of the message transmission between the interlocking STW and the signal S1; the description given below applies correspondingly to transmission of information between the interlocking STW and the other trackside components, i.e. the signals S2, S3, S4 and S5 and also the switches W1, W2 and W3.

FIG. 1 shows by way of example that the interlocking STW sends the following in each case with each message N(H(STW,S1),Ia,Iv1,Iv2) to the signal S1:
a current item of information Ia, which preferably involves a current item of command information or a current item of operational readiness information of the interlocking STW,
the respective previous information Iv1 in each case, which accordingly involves the previous command information or the previous operational readiness information of the interlocking STW, as well as
the respective information before last Iv2 in each case, which accordingly involves the command information before last or the operational readiness information before last of the interlocking STW.

Each message N(H(STW,S1),Ia,Iv1,Iv2) moreover preferably contains address information H(STW,S1), which indicates that the message originates from the interlocking STW and is directed to the signal S1.

The signal S1 works in a corresponding way: Thus FIG. 1 shows by way of example that the signal S1 sends the following in each case with each message N(H(S1,STW),Ia,Iv1,Iv2) to the interlocking STW:
a current item of information Ia, which preferably involves a current item of status information about the operating state of the signal S1 or a current item of operational readiness information of the signal S1,
the respective previous information Iv1, which accordingly involves the previous status information about the operating state of the signal S1 or the previous operational readiness information of the signal S1, as well as
The respective information before last Iv2, which accordingly involves the status information before last about the operating state of the signal S1 or the operational readiness information before last of the signal S1.

Each message N(H(STW,S1),Ia,Iv1,Iv2) moreover preferably contains address information H(S1,STW), which indicates that the message originates from the signal S1 and is directed to the interlocking STW.

FIG. 2 shows the railway system EBA in accordance with FIG. 1 and also a rail vehicle SF traveling on the tracks GL.

To make it possible for the signal control system STW to monitor and control the rail vehicle SF or at least also to make this possible and simplify it, the rail vehicle SF and the signal control system STW exchange messages in each case. With regard to the transmission technology, the messages can be transmitted in any given way, for example by wire or via cables laid in the tracks—for example within the framework of known point-type or line-type train influencing systems, as are generally known and are already being employed, or (as an alternative or in addition) by means of radio.

For the transmission of the messages, in order to enhance redundancy, a current item of information Ia as well as in addition the information sent in the last message is sent once again in each message in each case. In the exemplary embodiment in accordance with FIG. 2, it is assumed for example that, in addition to the current information Ia, two items of previous information are sent as well in each case, namely the previous information Iv1, which was sent as current information in the previous message and the information before last Iv2, which was sent as the current information in the message before last.

This will be explained below in more detail by way of example on the basis of the message transmission between the interlocking STW and the rail vehicle SF.

FIG. 2 shows for example that the interlocking STW sends the following in each case with each message N(H(STW,SF1),Ia,Iv1,Iv2) to the rail vehicle SF:
a current item of information Ia, which preferably involves a current item of command information or a current item of operational readiness information of the interlocking STW,
The respective previous information Iv1, which accordingly involves the previous command information or the previous operational readiness information of the interlocking STW, as well as
The respective information before last Iv2, which accordingly involves the command information before last or the operational readiness information before last of the interlocking STW.

Each message N(H(STW,SF),Ia,Iv1,Iv2) moreover preferably contains address information H(STW,SF), which indicates that the message originates from the interlocking STW and is directed to the rail vehicle SF.

The rail vehicle SF works in a corresponding way: Thus FIG. 2 shows for example that the rail vehicle SF sends the following in each case with each message N(H(SF,STW),Ia,Iv1,Iv2) to the interlocking STW:
a current item of information Ia, which preferably involves a current item of vehicle information of the rail vehicle SF or a current item of operational readiness information of the rail vehicle SF,
The respective previous information Iv1, which accordingly involves the previous vehicle information of the rail vehicle SF or the previous operational readiness information of the rail vehicle SF, as well as
The respective information before last Iv2, which accordingly involves the vehicle information before last of the rail vehicle SF or the operational readiness information before last of the rail vehicle SF.

The vehicle information preferably comprises details relating to the location of the rail vehicle SF established on the vehicle side and/or to the speed of the rail vehicle SF established on the vehicle side.

Each message N(H(SF,STW),Ia,Iv1,Iv2) moreover preferably contains address information H(SF,STW), which indicates that the message originates from the rail vehicle SF and is directed to the interlocking STW.

FIG. 3 shows the railway system EBA in accordance with FIG. 1 and also a first rail vehicle SF1 traveling on the tracks GL and a second rail vehicle SF2 traveling on the tracks GL.

To make possible a self-contained monitoring and control of the rail vehicles SF1 and SF2—be it autonomous without the interlocking STW or part-autonomous with the inclusion of the interlocking STW—the rail vehicles SF1 and SF2 each exchange messages. With regard to the transmission technology, the messages can be transmitted in any given way, for example by wire or via cables laid in the track GL—for example within the framework of known point-type or line-type train influencing systems, as are generally known and are already being employed, or (as an alternative or in addition) by means of radio.

For the transmission of the messages, in order to enhance redundancy, a current item of information Ia as well as in addition at least the information sent in the last message is sent once again in each message in each case. In the exemplary embodiment depicted in FIG. 3, it is assumed for example that, in addition to the current information Ia, two items of previous information are sent as well, namely the previous information Iv1, which was sent as current information in the previous message and the information before last Iv2, which was sent as the current information in the message before last.

This will be explained in more detail below by way of example on the basis of the message transmission between the rail vehicle SF1 and the rail vehicle SF2. FIG. 3 shows by way of example that the first rail vehicle SF1 sends the following in each case with each message N(H(SF1,SF2),Ia,Iv1,Iv2) to the second rail vehicle SF2:
a current item of information Ia, which preferably involves a current item of vehicle information of the first rail vehicle SF1 or a current item of operational readiness information of the first rail vehicle SF1,
the respective previous information Iv1, which accordingly involves the previous vehicle information of the first rail vehicle SF1 or the previous operational readiness information of the first rail vehicle SF1, as well as
the respective information before last Iv2, which accordingly involves the vehicle information before last or the operational readiness information before last of the first rail vehicle SF1.

Each message N(H(SF1,SF2),Ia,Iv1,Iv2) moreover preferably contains address information H(SF1,SF2), which indicates that the message originates from the first rail vehicle SF1 and is directed to the second rail vehicle SF2.

The second rail vehicle SF2 works in a corresponding way and sends corresponding messages to the first rail vehicle SF1, which are identified in FIG. 3 with reference characters N(H(SF2,SF1),Ia,Iv1,Iv2). What has been stated above in connection with FIG. 2 applies correspondingly.

The rail vehicles SF1 and SF2 can also exchange messages with the interlocking STW, as has been explained above in connection with FIG. 2, in order to include the interlocking STW in the monitoring and control.

FIG. 4, in a schematic view from above, shows a further exemplary embodiment of a railway system EBA. The railway system EBA in accordance with FIG. 4 comprises tracks GL, signals S1, S2, S3, S4 and S5, switches W1, W2 and W3, a first interlocking STW1 and a second interlocking STW2. In the diagram in accordance with FIG. 4 a first rail vehicle SF1 and a second rail vehicle SF2 are traveling on the tracks GL.

To make it possible for the two interlockings STW1 and STW2 to monitor and control the railway system, in particular the trackside components and the rail vehicles SF1 and SF2 or at least to simplify this process, the two interlockings STW1 and STW2 each exchange messages. With regard to the transmission technology, the messages can be transmitted in any given way, for example by wire or via cables and/or by means of radio.

For the transmission of the messages, in order to enhance redundancy, a current item of information Ia as well as in addition at least the information sent in the last message is sent once again in each message in each case. In the exemplary embodiment depicted in FIG. 4 it is assumed by way of example that, in addition to the current information Ia, two items of previous information are sent as well in each case, namely the previous information Iv1, which had been sent in the previous message as current information, and the information before last Iv2, which had been sent in the message before last as current information.

This will be explained below by way of example on the basis of the transmission of messages between the first interlocking STW1 and the second interlocking STW2.

FIG. 4 shows by way of example that the first interlocking STW1 sends the following to the second interlocking STW2 with each message N(H(STW1,STW2),Ia,Iv1,Iv2) in each case:
a current item of information Ia, which preferably involves a current item of interlocking information or a current item of operational readiness information of the first interlocking STW1,
The respective previous information Iv1, which accordingly involves the previous interlocking information or the previous operational readiness information of the first interlocking STW1,
The respective information before last Iv2, which accordingly involves the interlocking information before last or the operational readiness information before last of the first interlocking STW1.

Each message N(H(STW1,STW2),Ia,Iv1,Iv2) moreover preferably contains address information H(STW1,STW2), which indicates that the message originates from the first interlocking STW1 and is directed to the second interlocking STW2.

The second interlocking STW2 works in a similar or corresponding way and sends the corresponding messages to the first interlocking STW1, which are identified by the reference characters N(H(STW2,STW1),Ia,Iv1,Iv2).

As well as this, in the exemplary embodiment in accordance with FIG. 4, the rail vehicles SF1 and SF2 can also exchange messages with one another, with the two interlockings STW1 and STW2 or with at least one of the two interlockings, as has been explained above in connection with FIG. 2. The trackside components can communicate with both interlockings STW1 and STW2 or alternatively with just one of the two interlockings.

Although the invention has been illustrated and described in greater detail by preferred exemplary embodiments, the invention is not restricted by the examples disclosed and other variations can be derived herefrom by the person skilled in the art, without departing from the scope of protection of the invention.

1-15. (canceled)

16. A method for transmitting messages, which comprises the steps of:
forming each of the messages to contain a current item of information and information sent as current information in an immediately preceding message being previously transmitted and to be transmitted once again; and
transmitting the messages.

17. The method according to claim 16, which further comprises transmitting the messages between components of a railway system.

18. The method according to claim 17, wherein the railway system has trackside components and an interlocking controlling the trackside components.

19. The method according to claim 18, wherein the trackside components, in each message to the interlocking, send a current item of status information about an operational status of the trackside components in each case or current item of operational readiness information as well as in addition status information or operational readiness information sent to the interlocking in a last message in each case.

20. The method according to claim 18, wherein the interlocking, in each message to a trackside component, sends a current item of command information or a current item of operational readiness information as well as in addition command information or operational readiness information sent to the trackside component in a last message in each case.

21. The method according to claim 18, wherein:
the railway system has at least two interlockings; and
the messages are transferred between the interlockings.

22. The method according to claim 21, wherein each of the interlockings, in each message to the other of the interlockings, transfers a current item of interlocking information or a current item of operational readiness information in each case as well as in addition interlocking information or operational readiness information sent in a last message to the other interlocking in each case.

23. The method according to claim 21, wherein:
at least one rail vehicle is traveling on a section of track of the railway system; and
the messages are transmitted between the rail vehicle and the interlocking.

24. The method according to claim 23, wherein the rail vehicle, in each message to the interlocking, sends to the interlocking a current item of vehicle information or a current item of operational readiness information as well as in addition vehicle information or operational readiness information sent in a last message in each case.

25. The method according to claim 23, wherein the interlocking, in each message to the rail vehicle, sends to the rail vehicle a current item of command information or a current item of operational readiness information as well as in addition command information or operational readiness information sent in a last message in each case.

26. The method according to claim 21, wherein:
at least two rail vehicles are traveling on a section of track of the railway system; and
the messages are transmitted between the rail vehicles.

27. The method according to claim 26, wherein each rail vehicle, in each message to another rail vehicle, sends to the another rail vehicle a current item of vehicle information or a current item of operational readiness information as well as in addition vehicle information or operational readiness information sent in a last message in each case.

28. The method according to claim 21, wherein each of the messages further contains at least one further item of information that had been sent in a further preceding message as current information.

29. A railway component for a railway system, wherein the railway component is embodied such that it can send out messages wherein, in each message sent out, the railway component transfers a current item of information in each case and at least information sent out as current information in an immediately preceding message once again in each case.

30. The railway component according to claim 29, wherein the railway component is an interlocking, trackside component or a rail vehicle.
